(19) United States
(12) Patent Application Publication
(10) Pub. No.: US 2014/0209784 A1
(43) Pub. Date: Jul. 31, 2014

(54) IMAGE SENSING APPARATUS, DRIVING METHOD THEREFOR, AND IMAGE SENSING SYSTEM

(71) Applicant: CANON KABUSHIKI KAISHA, Tokyo (JP)

(72) Inventors: Kazumichi Morita, Kawasaki-shi (JP); Kazuhiro Sonoda, Kawasaki-shi (JP)

(73) Assignee: CANON KABUSHIKI KAISHA, Tokyo (JP)

(21) Appl. No.: 14/146,037

(22) Filed: Jan. 2, 2014

(30) Foreign Application Priority Data
Jan. 25, 2013 (JP) 2013-012437

(51) Int. Cl. H04N 5/378

(52) U.S. Cl. CPC H04N 5/378
USPC 250/208.1

(57) ABSTRACT

An image sensing apparatus comprising, a pixel array in which a plurality of pixels are arranged, a first A/D converter configured to perform first analog-to-digital conversion for a signal from the pixel array, a second A/D converter configured to perform second analog-to-digital conversion for the signal from the pixel array in parallel with the first analog-to-digital conversion by the first A/D converter, a first output unit configured to output one of a first result obtained by the first analog-to-digital conversion performed by the first A/D converter and a second result obtained by the second analog-to-digital conversion performed by the second A/D converter, and a second output unit configured to output information indicating which of the first result and the second result has been output from the first output unit.

### BACKGROUND OF THE INVENTION

1. Field of the Invention

The present invention relates to an image sensing apparatus, a driving method therefor, and an image sensing system.

2. Description of the Related Art

Japanese Patent Laid-Open No. 2011-35689 discloses the arrangement of an image sensing apparatus which parallelly performs two signal processes for a pixel signal from each column of a pixel array by associating two A/D converters with each column of the pixel array. Each of the two A/D converters includes a comparator and a counter. The two A/D comparators receive ramp signals with different change ranges, and compare the received ramp signals with a pixel signal, respectively. Each of the two counters measures the comparison time of a corresponding comparator, and outputs a measurement result (counter value).

With the above arrangement, two counter values are obtained from one pixel signal, and a digital signal corresponding to the pixel signal is obtained by adding the two counter values after data transferring. According to Japanese Patent Laid-Open No. 2011-35689, since one pixel signal is input to two A/D converters, and two ramp signals with different change ranges are used, the comparison time of each comparator is halved, thereby improving the frame rate of the image sensing apparatus.

In an image sensing apparatus of the type disclosed in Japanese Patent Laid-Open No. 2011-35689, for example, if a count value is represented by a hexadecimal number, one A/D converter serves to perform comparison and measurement for an analog signal corresponding to one of count values 0 to 7 among count values 0 (0000) to F (1111). The other A/D converter serves to perform comparison and measurement for an analog signal corresponding to one of count values 8 to F.

If, for example, an analog signal corresponding to a count value 3 is input, the count value 3 is obtained from one A/D converter and a maximum count value (a value of 0 indicating an overflow) is obtained from the other A/D converter, and these values are then added. If an analog signal corresponding to a count value B is input, a maximum count value (a value of 8 indicating an overflow) is obtained from one A/D converter and a count value B is obtained from the other A/D converter, and these values are then added.

Since one of the two data is a maximum count value indicating an overflow, it is not necessary to output the obtained two data intact. According to a data processing method described in Japanese Patent Laid-Open No. 2011-35689, an excessive amount of data is transferred. This may drive a bus with a heavy load especially when outputting data to an external IC, thereby increasing the power consumption.

### SUMMARY OF THE INVENTION

The present invention provides a technique advantageous in signal processing for a pixel signal.

One of the aspects of the present invention provides an image sensing apparatus comprising, a pixel array in which a plurality of pixels are arranged to form a plurality of rows and a plurality of columns, a first A/D converter configured to perform first analog-to-digital conversion for a signal from the pixel array, a second A/D converter configured to perform second analog-to-digital conversion for the signal from the pixel array in parallel with the first analog-to-digital conversion by the first A/D converter, a first output unit configured to output one of a first result obtained by the first analog-to-digital conversion performed by the first A/D converter and a second result obtained by the second analog-to-digital conversion performed by the second A/D converter, and a second output unit configured to output information indicating which of the first result and the second result has been output from the first output unit.

Further features of the present invention will become apparent from the following description of exemplary embodiments with reference to the attached drawings.

### BRIEF DESCRIPTION OF THE DRAWINGS

FIG. 1 is a circuit diagram for explaining an example of the arrangement of an image sensing apparatus according to the first embodiment;

FIG. 2 is a circuit diagram for explaining an example of the arrangement of the image sensing apparatus according to the first embodiment;

FIG. 3 is a circuit diagram for explaining an example of the arrangement of a selector of the image sensing apparatus according to the first embodiment;

FIG. 4 is a timing chart for explaining an operation of the image sensing apparatus according to the first embodiment;

FIG. 5 is a timing chart for explaining another operation of the image sensing apparatus according to the first embodiment;

FIG. 6 is a circuit diagram for explaining another example of the arrangement of the image sensing apparatus according to the first embodiment;

FIG. 7 is a timing chart for explaining still another operation of the image sensing apparatus according to the first embodiment;

FIG. 8 is a circuit diagram for explaining an example of the arrangement of an image sensing apparatus according to the second embodiment;

FIG. 9 is a timing chart for explaining an operation of the image sensing apparatus according to the second embodiment;

FIG. 10 is a timing chart for explaining another operation of the image sensing apparatus according to the second embodiment;

FIG. 11 is a circuit diagram for explaining an example of the arrangement of an image sensing apparatus according to the third embodiment;

FIG. 12 is a timing chart for explaining an operation of the image sensing apparatus according to the third embodiment;

FIG. 13 is a timing chart for explaining another operation of the image sensing apparatus according to the third embodiment;

FIG. 14 is a circuit diagram for explaining an example of the arrangement of an image sensing apparatus according to the fourth embodiment;

FIG. 15 is a circuit diagram for explaining another example of the arrangement of the image sensing apparatus according to the fourth embodiment; and

FIG. 16 is a timing chart for explaining an operation of the other example of the arrangement according to the fourth embodiment.

### DESCRIPTION OF THE EMBODIMENTS

### First Embodiment

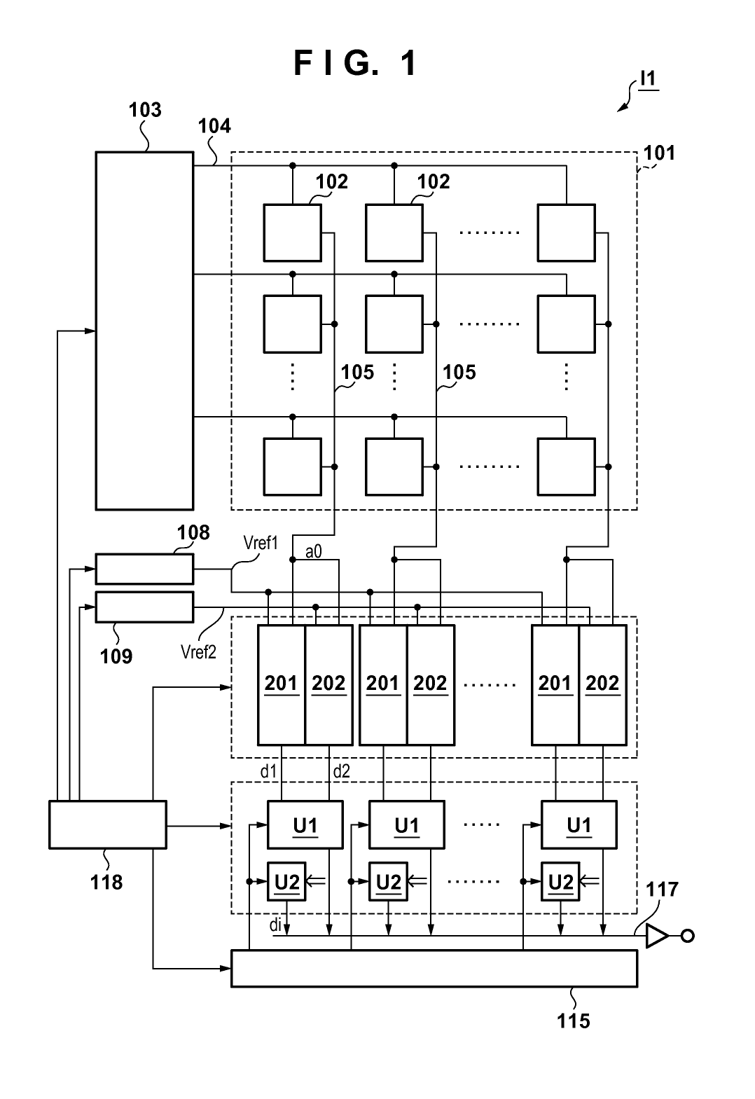

An image sensing apparatus I1 according to the first embodiment will be described with reference to FIGS. 1 to 7. FIG. 1 shows the arrangement of the image sensing apparatus I1. The image sensing apparatus I1 includes a pixel array 101, A/D converters 201 (first A/D converters), A/D converters 202 (second A/D converters), output units U1 (first output units), and output units U2 (second output units). The image sensing apparatus I1 can also include a timing generator 118, a vertical scanning circuit 103, a horizontal scanning circuit 115, and signal output units 108 and 109.

The pixel array 101 can be formed by arranging a plurality of pixels 102 to form a plurality of rows and a plurality of columns. Each pixel 102 need only have a known arrangement. For example, each pixel 102 can include a photoelectric conversion unit (for example, a photodiode), and one or more transistors for reading out a signal corresponding to a charge amount generated by the photoelectric conversion unit with incident light. Each transistor receives a control signal from the vertical scanning circuit 103 via a corresponding one of signal lines 104 arranged for the respective rows of the pixel array 101. This makes it possible to read out a signal (pixel signal) from each pixel 102 via a corresponding column signal line 105.

The A/D converters 201 and 202 and the output units U1 and U2 are provided on, for example, each column of the pixel array 101. The A/D converter 201 analog-to-digital-converts (A/D-converts) a signal a0 (analog signal) from the pixel array 101 (first analog-to-digital conversion). The A/D converter 202 can be connected in parallel with the A/D converter 201. The A/D converter 202 A/D-converts the signal a0 from the pixel array 101 simultaneously with A/D conversion performed by the A/D converter 201 (second analog-to-digital conversion).

The output unit U1 outputs one of a digital signal d1 (first result) obtained by A/D conversion performed by the A/D converter 201 and a digital signal d2 (second result) obtained by A/D conversion performed by the A/D converter 202. The output unit U2 outputs information d1 indicating which of the digital signals d1 and d2 has been output from the output unit U1.

The horizontal scanning circuit 115 controls to read out outputs (data) from the output units U1 and U2 of each column, and sequentially, horizontally transfer the data via a bus 117, thereby outputting the data to an external circuit (for example, a processing unit for performing data processing) (not shown). The timing generator 118 supplies a reference signal or control signal including a clock signal to each of the above-described modules, which then performs an operation according to its arrangement.

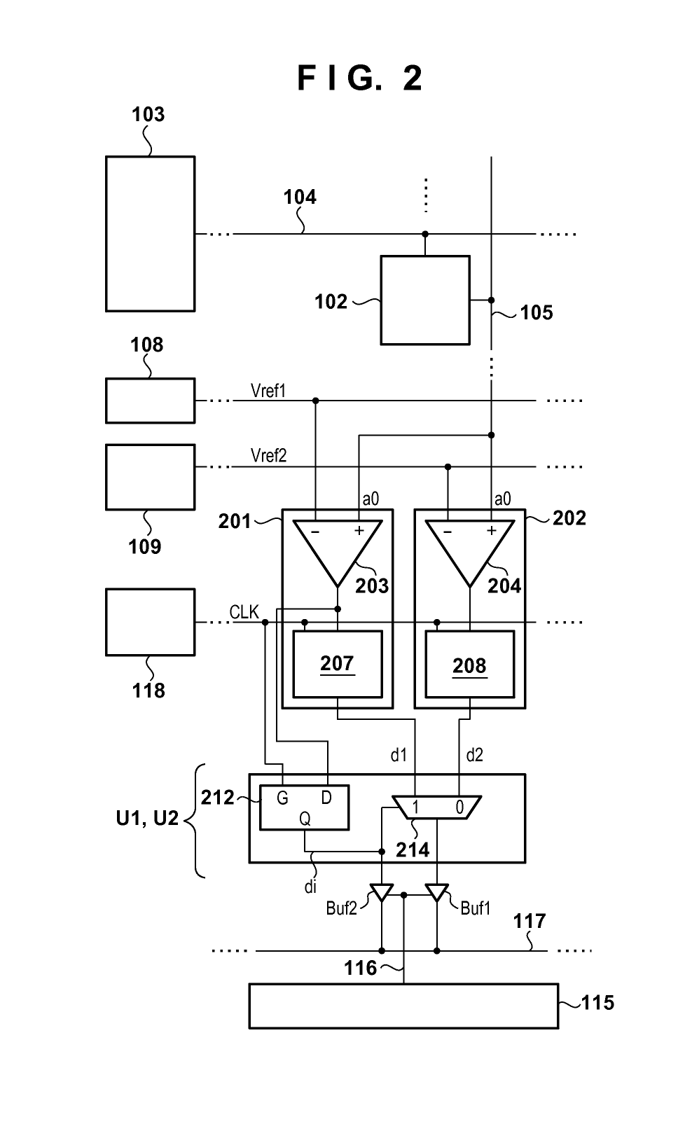

FIG. 2 shows a detailed example of the arrangement of a portion of the image sensing apparatus I1, which includes the A/D converters 201 and 202 and the output units U1 and U2 corresponding to one column of the pixel array 101. The A/D converter 201 includes, for example, a comparator 203 and a counter 207. The A/D converter 201 performs A/D conversion by comparing the signal a0 from the pixel array 101 with a ramp signal Vref1 (first reference signal) using the comparator 203 and the counter 207. For example, the ramp signal Vref1 can be supplied from the signal output unit 108 to the A/D converter 201. The counter 207 measures the time until the magnitude relationship between the signal a0 from the pixel array 101 and the ramp signal Vref1 is reversed using, for example, a clock signal CLK from the timing generator 118. The counter 207 performs at least one of a count-up operation and a count-down operation.

Similarly to the A/D converter 201, the A/D converter 202 compares the signal a0 from the pixel array 101 with a ramp signal Vref2 (second reference signal) different from the ramp signal Vref1. For example, the ramp signal Vref2 can be supplied from the signal output unit 109 to the A/D converter 202. The ramp signals Vref1 and Vref2 have, for example, the same slope, and the ramp signal Vref2 includes an offset component with respect to the ramp signal Vref1. As described above, the signal a0 from the pixel array 101 undergoes two A/D conversion processes at the same time, thereby obtaining the digital signals d1 and d2.

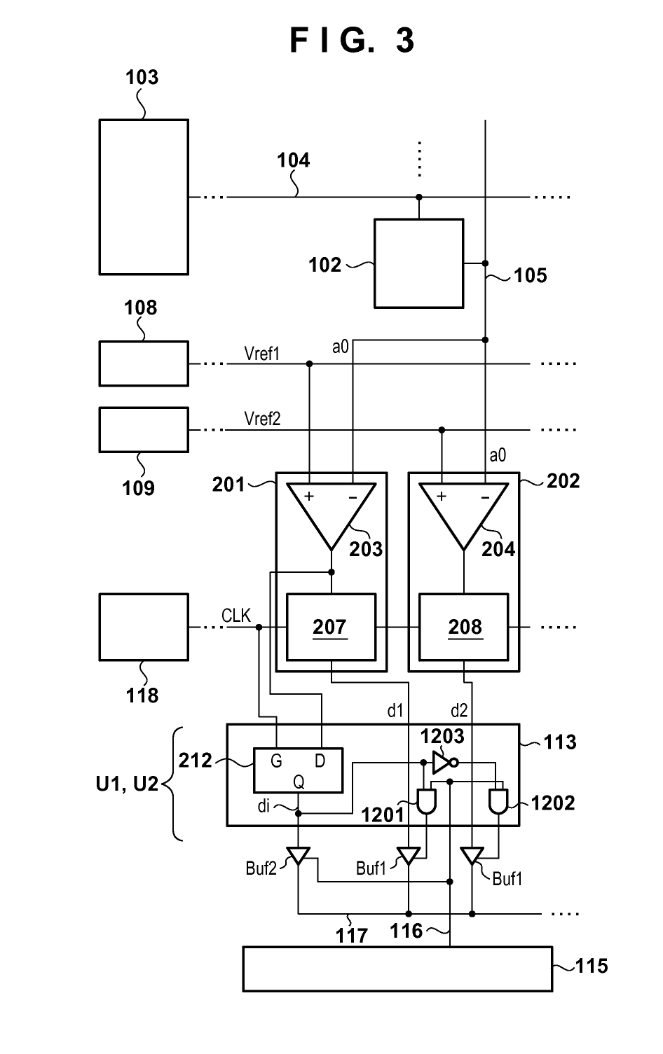

The output unit U1 outputs one of the digital signals d1 and d2. The output unit U2 outputs the information d1 indicating which of the digital signals d1 and d2 has been output from the output unit U1. The output unit U1 can be formed by, for example, a selector 214 and a buffer Buf1. The output unit U2 can be formed by, for example, a latch 212 and a buffer Buf2. Each of the buffers Buf1 and Buf2 can receive, from the horizontal scanning circuit 115 via a signal line 116, a control signal for horizontal transferring. The latch 212 holds an output from the comparator 203. Based on the information held by the latch 212, the selector 214 selects and outputs one of the digital signals d1 and d2. For example, the selector 214 need only output one of two input signals based on a predetermined control signal, and can be formed by logical circuits such as AND circuits and an inverter, as shown in FIG. 3. The signal from each of the output units U1 and U2 can be output to, for example, the bus 117 via the buffer.

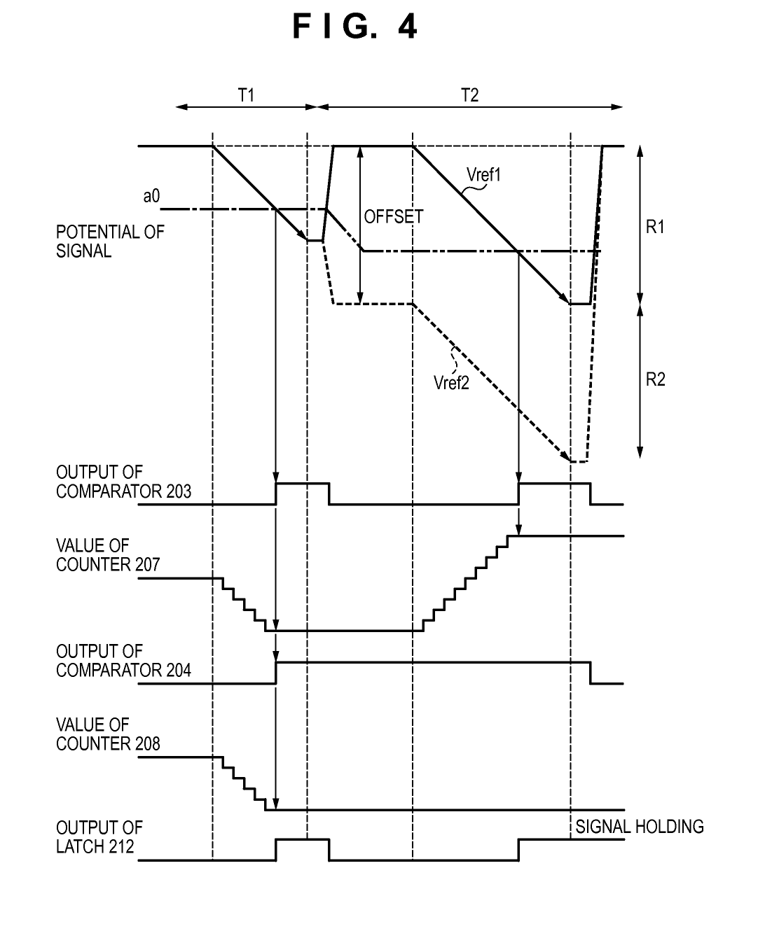

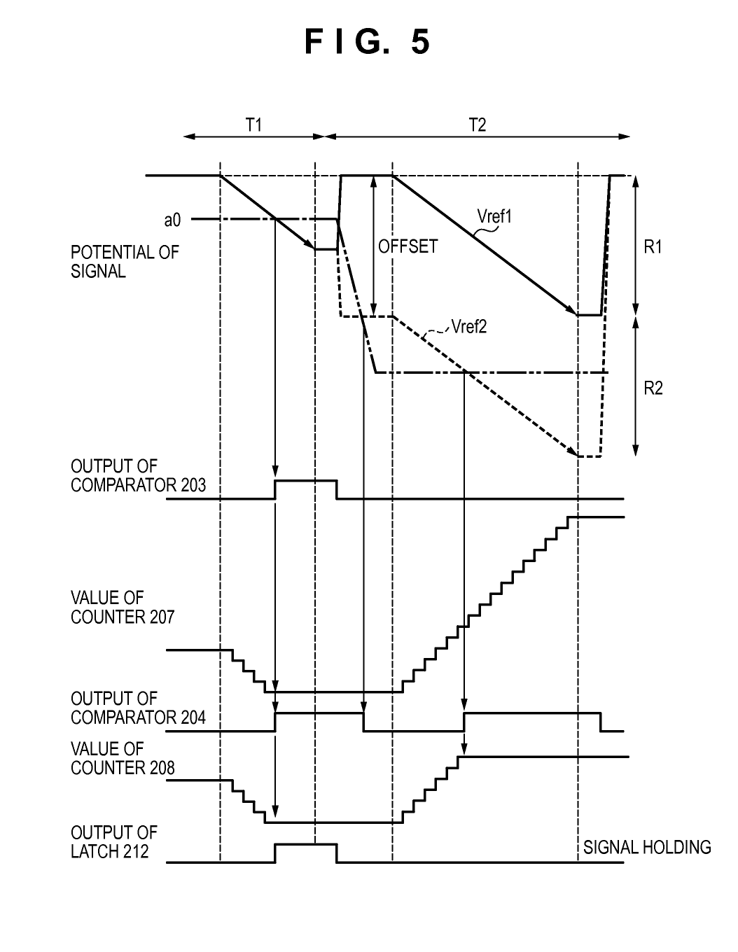

A procedure of reading out a pixel signal in the image sensing apparatus I1 will be described below with reference to FIGS. 4 and 5. The image sensing apparatus I1 performs a first signal readout operation during a first period T1 and performs a second signal readout operation during a second period T2. During the first period T1, a signal (to be referred to as an N component hereinafter) immediately after the state of the pixel 102 is initialized (reset) can be read out. During the second period T2, a signal (to be referred to as an S component hereinafter) can be read out from the pixel 102 after a predetermined time elapses since the initialization. After that, the difference between the two signals undergoes A/D conversion. Note that the S component depends on a charge amount generated in the pixel 102, that is, the amount of light incident on the pixel 102. Therefore, for example, as the amount of incident light is larger, the difference between the N and S components is larger, and vice versa. Note also that a method of reading out a pixel signal is not limited to the circuit arrangement exemplified in this embodiment. For example, a circuit arrangement according to a correlated double sampling (CDS) method may be adopted. If a CDS circuit is provided between the pixel array 101 and the A/D converters 201 and 202, a signal obtained by resetting the input unit of the CDS circuit can be read out as an N component during the first period T1. Furthermore, a signal output from the pixel 102 via the CDS circuit can be read out as an S component during the second period T2.

FIG. 4 is a timing chart showing the operation of the image sensing apparatus I1 when the amount of light incident on the pixel 102 is small, that is, the luminance level is low (at a low luminance). During the first period T1, the timing generator 118 outputs an enable signal for A/D-converting an N-component signal, thereby performing a first comparison operation. During the first period T1, the A/D converter 201 compares the N-component signal with the ramp signal Vref1. In this comparison operation, the counter 207 performs a count-down operation. When the magnitude relationship between the two signals is reversed (for example, when the output of the comparator 203 changes from low level to high level), the count-down operation of the counter 207 is stopped. Similarly to the A/D converter 201, the A/D converter 202 compares the N-component signal with the ramp signal Vref2.

During the second period T2, the timing generator 118 outputs an enable signal for A/D-converting an S-component signal, thereby performing a second comparison operation. During the second period T2, the A/D converter 201 compares the S-component signal with the ramp signal Vref1. In this comparison operation, the counter 207 performs a count-up operation. When the magnitude relationship between the two signals is reversed, the count-up operation of the counter 207 is stopped. Based on the result of the count-down operation during the first period T1 and that of the count-up operation during the second period T2, a change from the initial value of the counter 207 can be obtained as a digital signal to be acquired.

Furthermore, during the second period T2, the A/D converter 202 can compare the S-component signal with the ramp signal Vref2, similarly to the A/D converter 201. As described above, the ramp signals Vref1 and Vref2 have, for example, the same slope, and the ramp signal Vref2 includes an offset component with respect to the ramp signal Vref1. In this example in which the luminance level is low, the comparison result of a comparator 204 of the A/D converter 202 remains reversed (in this example, the output of the comparator 204 remains at high level) after the first period T1. That is, in the A/D converter 202, the signal a0 from the pixel array exceeds a range within which comparison by the comparator 204 is possible and, therefore, a count-up operation by a counter 208 may be omitted.

In this example in which the luminance level is low, the latch 212 holds high level “1” which is output from the comparator 203 of the A/D converter 201. Based on this information, the selector 214 selects and outputs the digital signal d1.

FIG. 5 is a timing chart showing the operation of the image sensing apparatus I1 when the amount of light incident on the pixel 102 is large, that is, the luminance level is high (at a high luminance), similarly to FIG. 4. An operation during the first period T1 is the same as that shown in FIG. 4 and a description thereof will be omitted. Since an S component is large during the second period T2 in this example in which the luminance level is high, the comparison result of the comparator 203 of the A/D converter 201 is not reversed (remains at low level in this example) after the first period T1. On the other hand, the comparison result of the comparator 204 of the A/D converter 202 is reversed (changes from low level to high level in this example) after the first period T1. In this example in which the luminance level is high, therefore, the latch 212 holds low level “0”, based on which the selector 214 selects and outputs the digital signal d2.

With the arrangement of the image sensing apparatus I1, the ramp signal Vref1 can be used for, for example, comparison with a signal falling within one (for example, range R1) of a first range R1 and a second range R2 of the dynamic range of the signal a0 from the pixel array 101. Furthermore, the ramp signal Vref2 can be used for comparison with a signal falling within the other (for example, range R2) of the ranges R1 and R2. By using these two reference signals to parallelly perform two A/D conversion processes for one analog signal (pixel signal a0) read out from the pixel array 101, two digital signals (the digital signals d1 and d2) are obtained.

The output unit U1 outputs one of the two digital signals, and the output unit U2 outputs information (information d1) indicating which of the two digital signals has been output from the output unit U1. The image sensing apparatus I1 need only send the outputs (digital signals) of the output units U1 and U2 to an external module as, for example, a digital signal containing the information d1 as a one-bit header. That is, the image sensing apparatus I1 generates a digital signal added with one-bit information as a header. This decreases the data amount of a digital signal processed by an external module (for example, the above-described processing unit) as the output destination of the image sensing apparatus I1 and, for example, data processing such as addition processing for two digital signals can be omitted. As described above, according to this embodiment, signal processing for a signal obtained by the image sensing apparatus I1 is facilitated, which is thus advantageous in, for example, increasing the speed of image processing and reducing the power consumption.

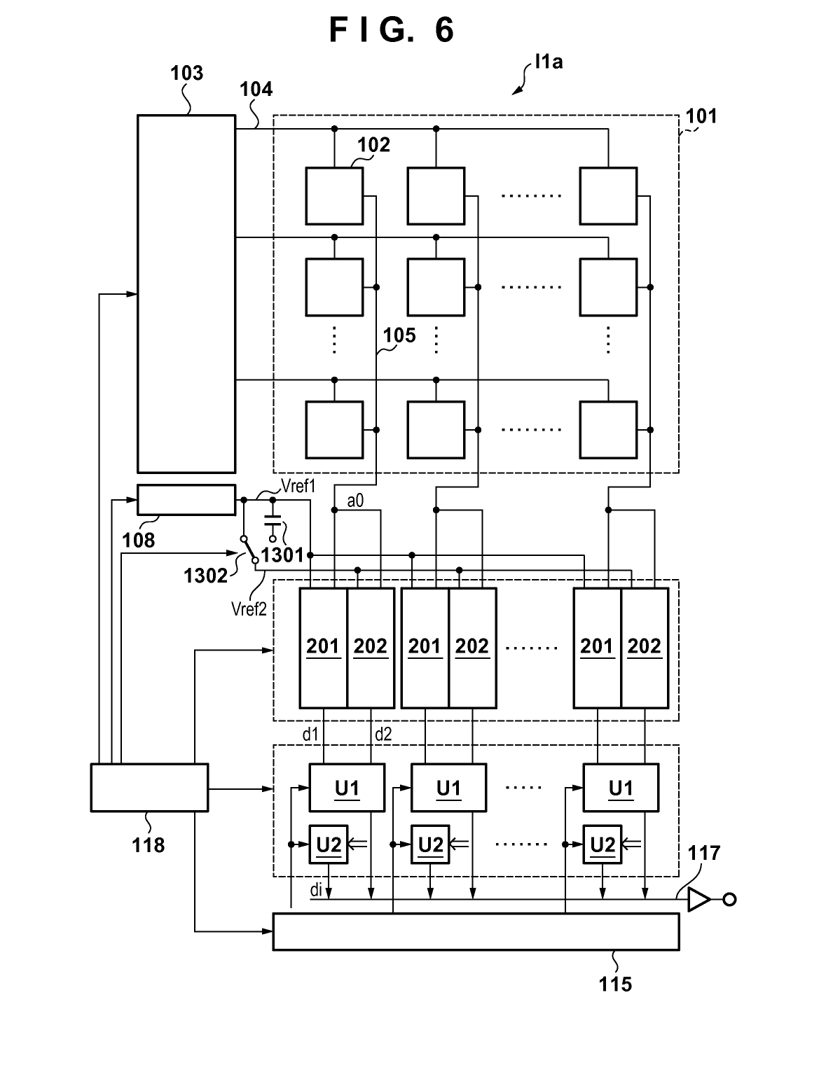

Although the arrangement in which the signal output units 108 and 109 output the ramp signals Vref1 and Vref2, respectively, has been described in the above embodiment, the present invention is not limited to this. For example, an image sensing apparatus I1a includes a capacitor 1301 and a signal output unit 108X, and may generate two ramp signals by switching the connection relationship between the capacitor 1301 and the signal output unit 108X using a switch 1302, as shown in FIG. 6. More specifically, the signal output unit 108X outputs a signal with a ramp waveform after charging the capacitor 1301. The image sensing apparatus I1a can use the signal as the ramp signal Vref1, and use a signal including the voltage of the capacitor generated by the charging as an offset component with respect to the ramp signal Vref1 as the ramp signal Vref2.

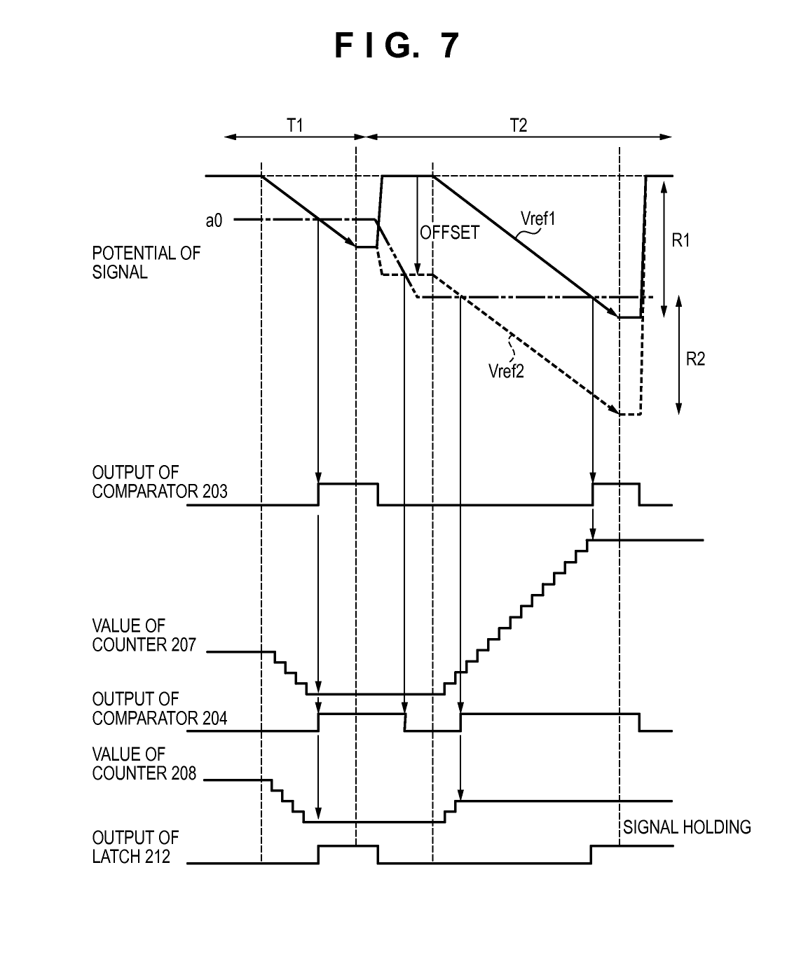

In the above-described embodiment, the arrangement in which two A/D conversion processes are performed using the ramp signals Vref1 and Vref2 having the same slope has been explained. However, it is also possible to perform two A/D conversion processes using the ramp signals Vref1 and Vref2 having different slopes. For example, it suffices that the ranges R1 and R2 have different range widths and the ratio between the slopes of the ramp signal Vref1 and ramp signal Vref2 depends on the ratio between the range widths of the ranges R1 and R2. Furthermore, as exemplified in FIG. 7, the ranges R1 and R2 may overlap each other as long as they do not depart from the spirit and scope of the present invention.

### Second Embodiment

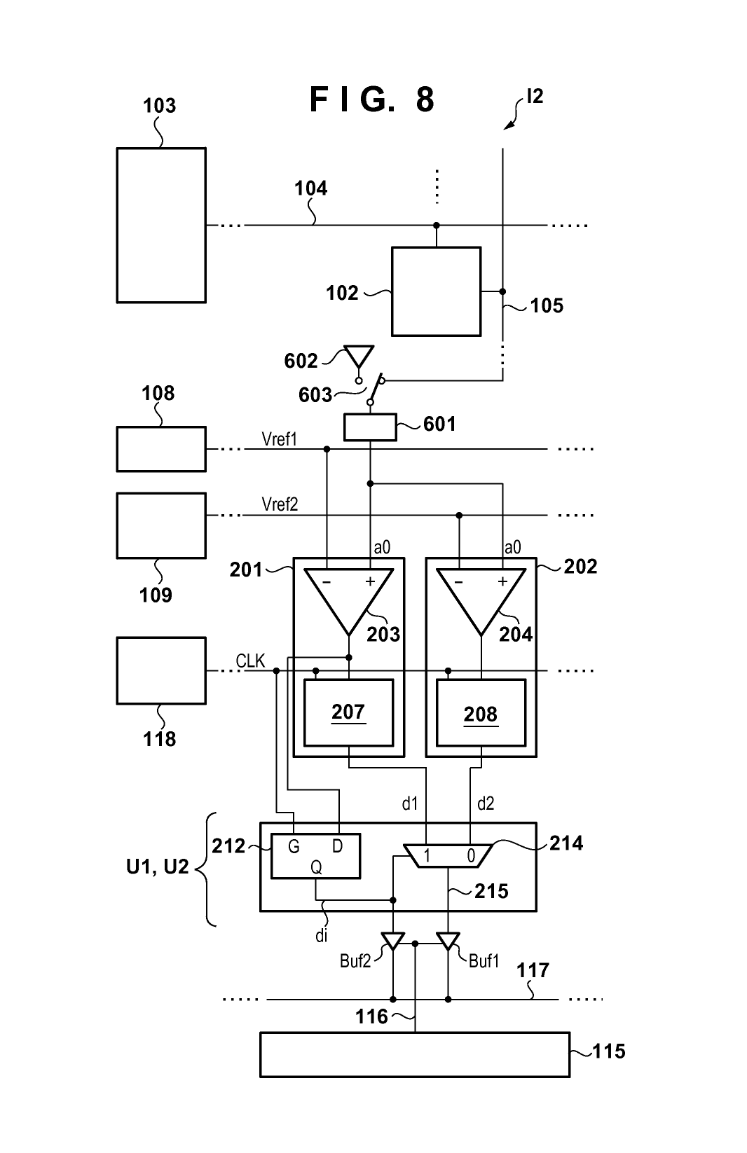

An image sensing apparatus I2 according to the second embodiment will be described with reference to FIGS. 8 to 10. An arrangement for performing A/D conversion according to this embodiment is different from that in the first embodiment. The image sensing apparatus I2 can include a constant voltage source 602 (first unit) and an integration circuit 601 (second unit), as exemplified in FIG. 8. The constant voltage source 602 need only output, for example, a constant signal (for example, a negative voltage) having a polarity different from that of a signal a0 (for example, a positive voltage) from a pixel array 101.

The integration circuit 601 can be connected to one of the pixel array 101 (a column signal line 105 thereof) and the constant voltage source 602 using a switch 603. The integration circuit 601 integrates the signal from the constant voltage source 602 after integrating the signal a0 from the pixel array 101.

An A/D converter 201 performs A/D conversion by comparing an output signal i0 from the integration circuit 601 with a reference signal Vref1 (first reference signal) (first analog-to-digital conversion). On the other hand, an A/D converter 202 performs A/D conversion by comparing the output signal from the integration circuit 601 with a reference signal Vref2 (second reference signal) different from the reference signal Vref1 (second analog-to-digital conversion). In this embodiment, signals each having a rectangular waveform can be used as the reference signals Vref1 and Vref2 from signal output units 108 and 109 instead of signals each having a ramp waveform.

The rectangular waveforms of the reference signals Vref1 and Vref2 have different values. The reference signal Vref2 includes an offset component with respect to the reference signal Vref1. The reference signal Vref1 can be used for comparison with a signal falling within one (for example, range R1) of ranges R1 and R2 of the dynamic range of the output signal i0 from the integration circuit 601. The reference signal Vref2 can be used for comparison with a signal falling within the other (for example, range R2) of the ranges R1 and R2.

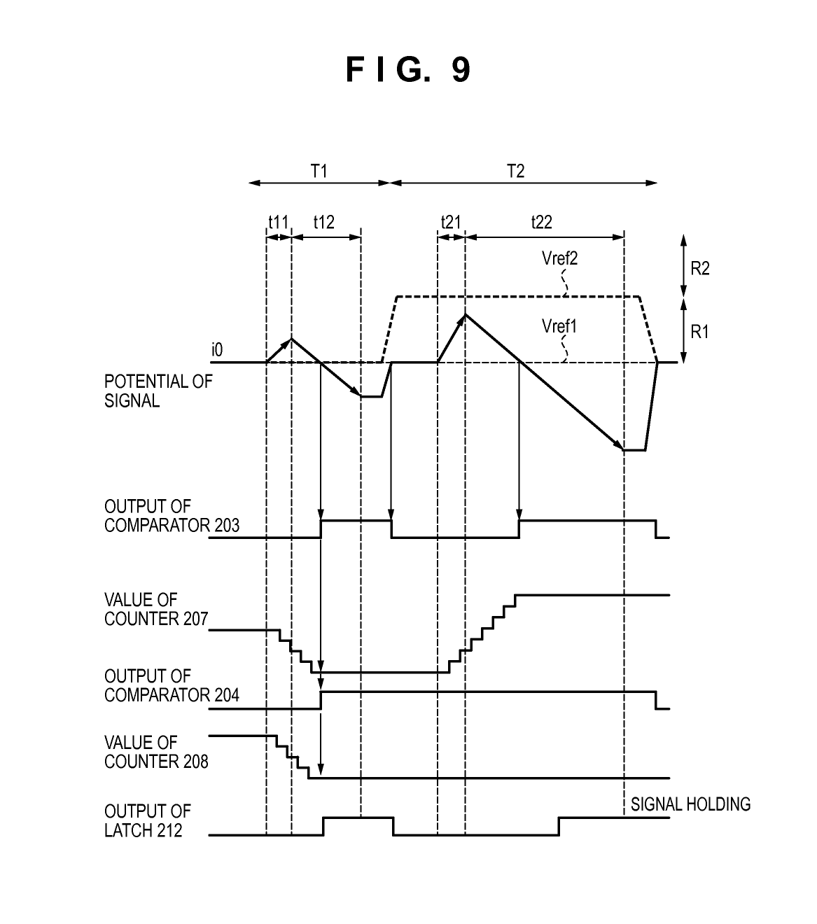

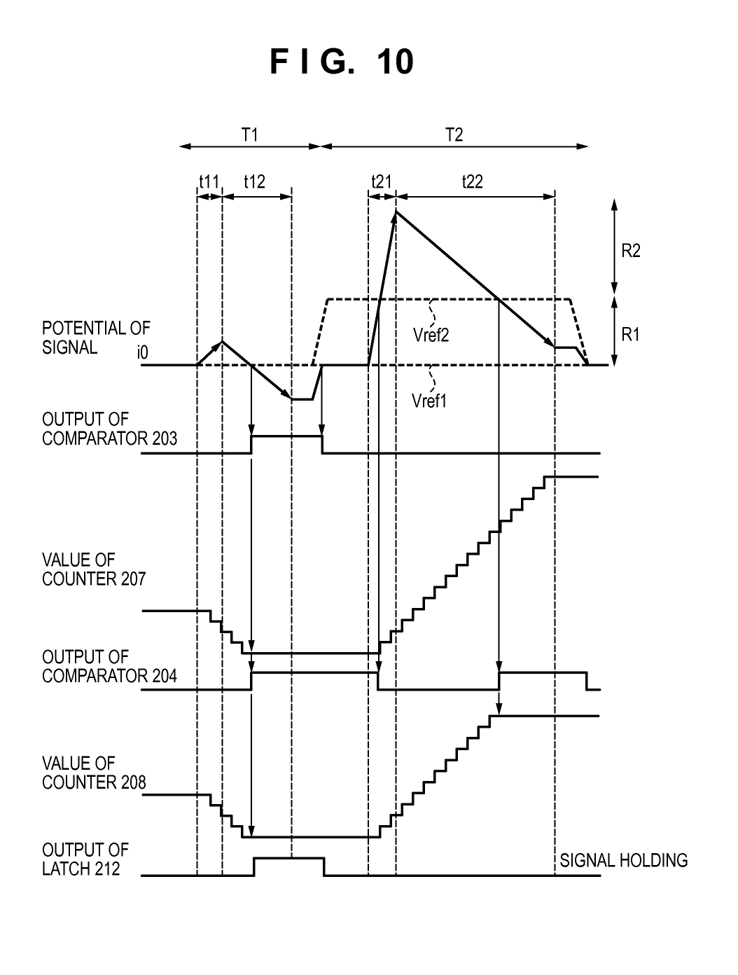

Similarly to the first embodiment, a procedure of reading out a signal from the pixel array 101 of the image sensing apparatus I2 will be described below with reference to FIGS. 9 and 10.

FIG. 9 is a timing chart showing the operation of the image sensing apparatus I2 when the luminance level is low. Similarly to the first embodiment, a first comparison operation is performed during a first period T1. More specifically, in this embodiment, during a term t11 of the first period T1, the integration circuit 601 is connected to the column signal line 105 by the switch 603, and an N-component signal of the pixel array 101 is input to the integration circuit 601, thereby raising the output i0 of the integration circuit 601. After that, during a term t12, the integration circuit 601 is connected to the constant voltage source 602 by the switch 603, and the output i0 of the integration circuit 601 drops since a signal from the constant voltage source 602 has a polarity opposite to that of the N-component signal of the pixel array 101. The A/D converter 201 compares the output i0 of the integration circuit 601 with the reference signal Vref1. When the magnitude relationship between the output i0 of the integration circuit 601 and the reference signal Vref1 is reversed (for example, when the output of a comparator 203 changes from low level to high level), a count-down operation by a counter 207 is stopped. The A/D converter 202 also performs an operation similar to that of the A/D converter 201.

During a second period T2, a second comparison operation is performed. More specifically, during a term t21 of the second period T2, the integration circuit 601 is connected to the column signal line 105 by the switch 603, and an S-component signal of the pixel array 101 is input to the integration circuit 601, thereby raising the output i0 of the integration circuit 601. After that, during a term t22, the integration circuit 601 is connected to the constant voltage source 602 by the switch 603, and the output i0 of the integration circuit 601 drops. In the A/D converter 201, when the magnitude relationship between the output i0 of the integration circuit 601 and the reference signal Vref1 is reversed and the output of the comparator 203 changes from low level to high level, a count-down operation by the counter 207 is stopped.

During the second period T2, the A/D converter 202 can compare the output i0 of the integration circuit 601 with the reference signal Vref2, similarly to the A/D converter 201. As described above, the reference signal Vref2 includes an offset component with respect to the reference signal Vref1. In this example in which the luminance level is low, the comparison result of a comparator 204 of the A/D converter 202 remains reversed (in this example, the output of the comparator 204 remains at high level) after the first period T1, and a counter 208 need not perform a count-up operation.

Similarly to the first embodiment, therefore, in this example in which the luminance level is low, a latch 212 holds high level “1”, based on which a selector 214 selects and outputs a digital signal d1.

FIG. 10 is a timing chart showing the operation of the image sensing apparatus I2 when the luminance level is high. An operation during the first period T1 is the same as that shown in FIG. 9 and a description thereof will be omitted. Since an S component is large during the second period T2 in this example in which the luminance level is high, the comparison result of the comparator 203 of the A/D converter 201 is not reversed (remains at low level in this example) after the first period T1. On the other hand, the comparison result of the comparator 204 of the A/D converter 202 is reversed (changes from low level to high level in this example) after the first period T1. In this example in which the luminance level is high, therefore, the latch 212 holds low level “0”, based on which the selector 214 selects and outputs a digital signal d2.

The arrangement for performing A/D conversion according to this embodiment, which is different from that in the first embodiment, has been explained above. According to the arrangement of this embodiment, it is also possible to obtain the same effects as those in the first embodiment.

### Third Embodiment

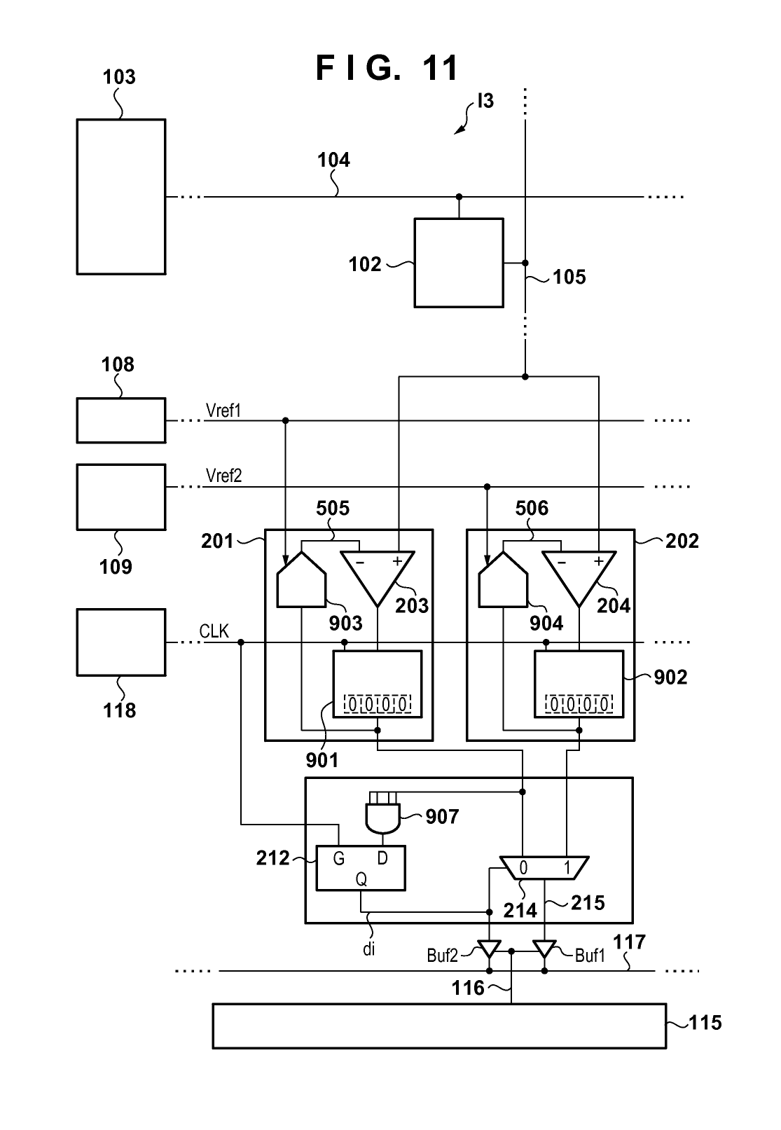

An image sensing apparatus I3 according to the third embodiment will be described with reference to FIGS. 11 to 13. An arrangement for performing A/D conversion according to this embodiment is different from that in the first or second embodiment, as shown in FIG. 11. The image sensing apparatus I3 can include an A/D converter 201, a register 901 (first register), a D/A converter 903 (first D/A converter), and a comparator 203 (first comparator). The D/A converter 903 converts the value of the register 901 into an analog signal a1 (first analog signal) using a reference signal Vref1 as a reference potential. The comparator 203 compares a signal a0 from a pixel array 101 with the analog signal a1.

Similarly to the A/D converter 201, an A/D converter 202 can include a register 902 (second register), a D/A converter 904 (second D/A converter), and a comparator 204 (second comparator). The D/A converter 904 converts the value of the register 902 into an analog signal a2 (second analog signal) using a reference signal Vref2 as a reference potential. The comparator 204 compares the signal a0 from the pixel array 101 with the analog signal a2.

The analog signal a2 includes an offset component with respect to the analog signal a1. The analog signal a1 can be used for comparison with a signal falling within one (for example, range R1) of ranges R1 and R2 of the dynamic range of the signal a0 from the pixel array 101. The analog signal a2 can be used for comparison with a signal falling within the other (for example, range R2) of the ranges R1 and R2.

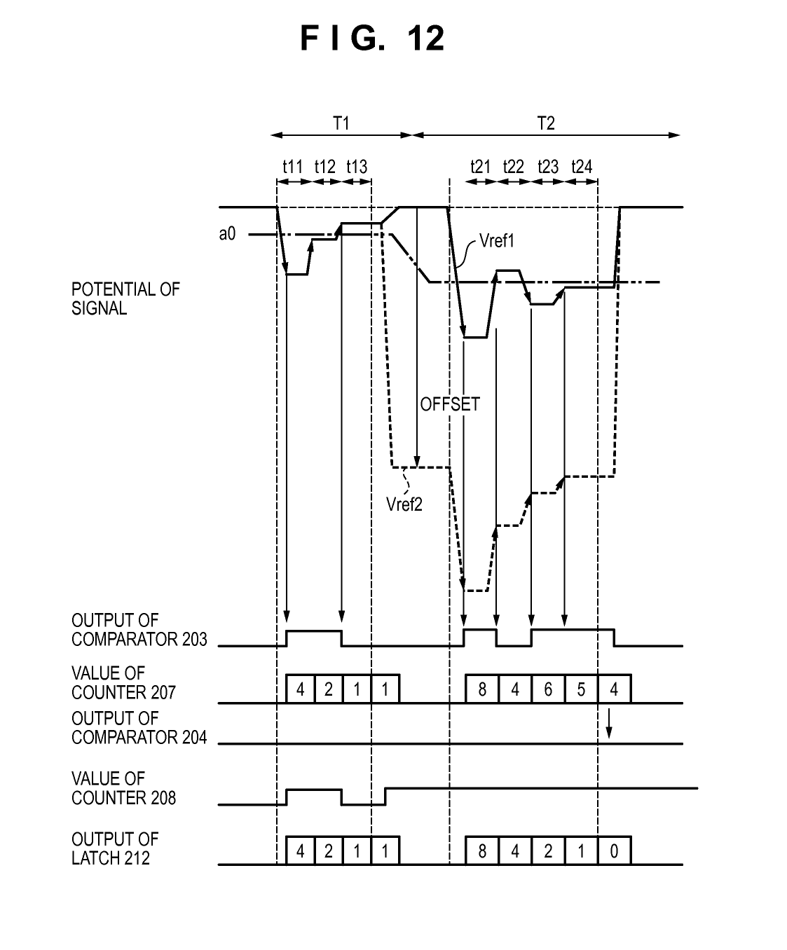

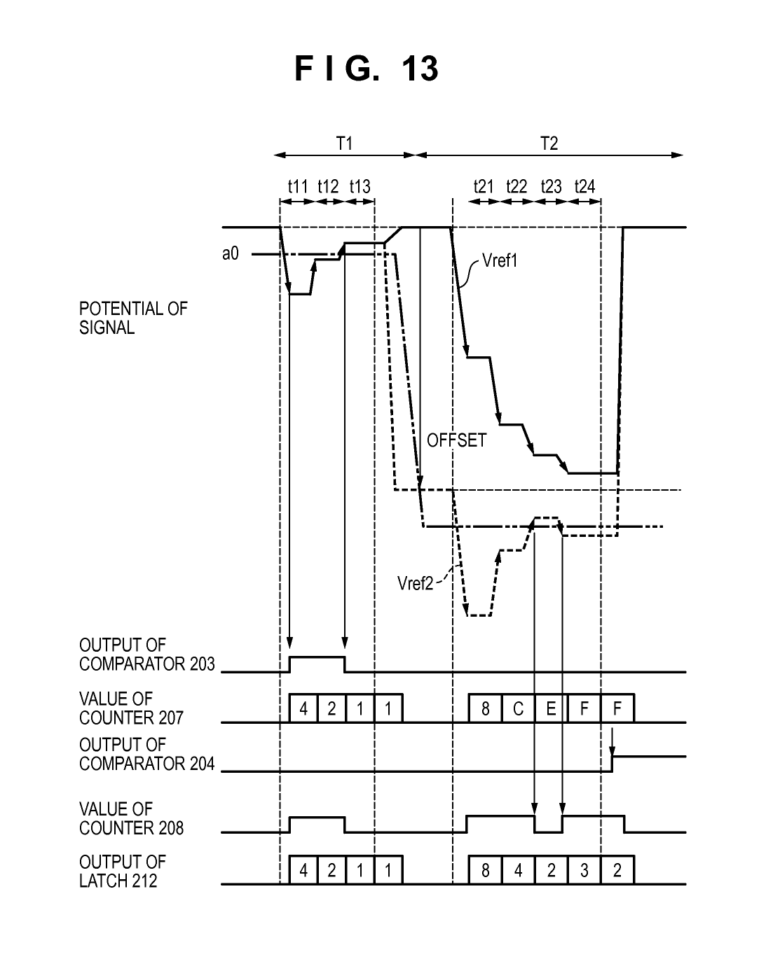

Similarly to the first and second embodiments, a procedure of reading out the signal a0 from the pixel array 101 of the image sensing apparatus I3 will be described below with reference to FIGS. 12 and 13.

FIG. 12 is a timing chart showing the operation of the image sensing apparatus I3 when the luminance level is low. During a first period T1, a first comparison operation is performed. More specifically, during the first period T1, the A/D converter 201 compares the signal a0 from the pixel array 101 with the analog signal a1 while sequentially changing the value of the register 901. During a term t11 of the first period T1, the comparator 203 compares the output of the D/A converter 903 when the register 901 is set to “4” (a binary number of 0100), that is, the analog signal a1 with the signal a0. As a result, the output of the comparator 203 changes from low level to high level.

After that, during a term t12, the register 901 is set to “2” (a binary number of 0010), and the comparator 203 compares the analog signal a1 with the signal a0. Since the magnitude relationship between the analog signal a1 and the signal a0 is not reversed, the output of the comparator 203 remains at high level. Furthermore, during a term t13, the register 901 is set to “1” (a binary number of 0001), and the comparator 203 compares the analog signal a1 with the signal a0. The magnitude relationship between the analog signal a1 and the signal a0 is reversed, and the output of the comparator 203 changes from high level to low level. As described above, the value “1” (a binary number of 0001) of the register 901 can be obtained as a result of the first comparison operation, and held in, for example, a register (not shown). The A/D converter 202 can also perform an operation similar to that of the A/D converter 201.

During a second period T2, a second comparison operation is performed. During a term t21 of the second period T2, the register 901 is set to “8” (a binary number of 1000), and the comparator 203 compares the analog signal a1 with the signal a0. As a result, the output of the comparator 203 changes from low level to high level. After that, during a term t22, the register 901 is set to “4” (a binary number of 0100), and the output of the comparator 203 changes from high level to low level. During a term t23, the register 901 is set to “6” (a binary number of 0110), and the output of the comparator 203 changes from low level to high level. Furthermore, during a term t24, the register 901 is set to “5” (a binary number of 0101), and the output of the comparator 203 remains at high level. The values of the four bits of the register 901 are input to the respective input terminals of a four-input AND circuit 907. In this example in which the luminance level is low, the value of the register 901 is “0101” and thus “0” is input to a latch 212.

Note that during the second period T2, the A/D converter 202 can compare the analog signal a2 with the signal a0, similarly to the A/D converter 201. As described above, the analog signal a2 includes an offset component with respect to the analog signal a1. In this example in which the luminance level is low, the output of the comparator 204 is also at high level.

In this manner, the value “5” (a binary number of 0101) of the register 901 is obtained as a result of the second comparison operation. In this example in which the luminance level is low, the latch 212 holds “0” output from the four-input AND circuit 907. Based on the output, a selector 214 selects and outputs the difference between the first comparison operation and the second comparison operation in the A/D converter 201 as a digital signal d1 to be acquired.

FIG. 13 is a timing chart showing the operation of the image sensing apparatus I3 when the luminance level is high. An operation during the first period T1 is the same as that shown in FIG. 12 and a description thereof will be omitted. On the other hand, in this example in which the luminance level is high, during the second period T2, comparison between the analog signal a1 and the signal a0 is performed by a procedure similar to that described above but an S component is large. Therefore, the comparison result of the comparator 203 is not reversed (remains at low level) after the first period T1. As a result, the value of the register 901 changes up to “F” (a binary number of 1111). In this example in which the luminance level is high, since the value of the register 901 is “1111”, “1” is input to the latch 212.

On the other hand, the comparison result of the comparator 204 of the A/D converter 202 is reversed after the first period T1, and comparison between the analog signal a2 and the signal a0 is performed by a procedure similar to that described above. The value “3” (a binary number of 0011) of the register 902 is obtained as a result of the second comparison operation. In this example in which the luminance level is high, the latch 212 holds “1” output from the four-input AND circuit 907. Based on the output, the selector 214 selects and outputs the difference between the first comparison operation and the second comparison operation in the A/D converter 202 as a digital signal d2 to be acquired.

The arrangement for performing A/D conversion according to this embodiment, which is different from that in the first or second embodiment, has been explained above. According to the arrangement of this embodiment, it is also possible to obtain the same effects as those in the first and second embodiments.

### Fourth Embodiment

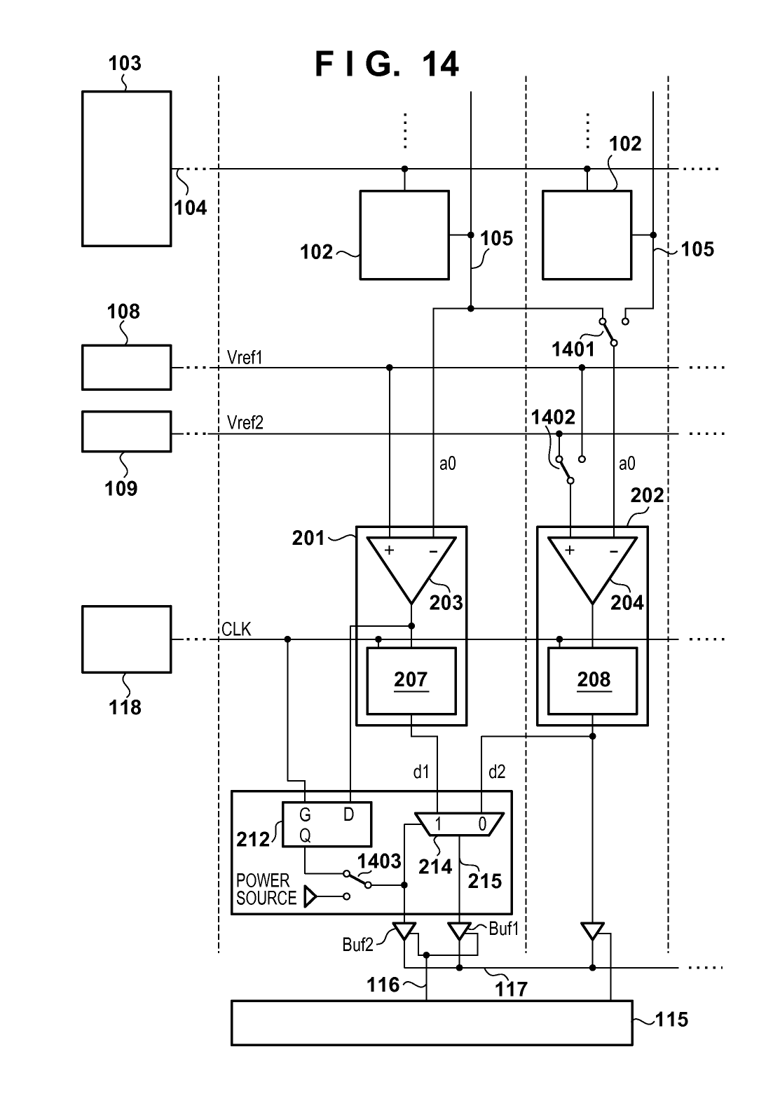

An image sensing apparatus I4 according to the fourth embodiment will be described with reference to FIGS. 14 to 16. In the first to third embodiments, the arrangement in which two A/D converters (A/D converters 201 and 202) are provided on each of the plurality of columns of the pixel array 101 has been explained. In this embodiment, however, an arrangement is changed depending on an operation mode.

In the image sensing apparatus I4, one A/D converter can be arranged on each column of a pixel array 101. As shown in FIG. 14, for example, an A/D converter 201 is arranged on the L1th column (L1 is an odd number) and an A/D converter 202 is arranged on the L2th column (L2 is an even number). In other words, the L1th column is one column of a first group (odd-numbered columns) and the L2th column is one column of a second group (even-numbered columns).

The image sensing apparatus I4 can include, for example, a first mode and a second mode as operation modes. In the first mode, a signal is read out from each of the plurality of columns of the pixel array 101, thereby performing a so-called full readout operation. In the second mode, a signal is read out from, for example, each pixel of the first group (odd-numbered columns in this example) of the plurality of columns of the pixel array 101, thereby performing a so-called thinning readout operation. The image sensing apparatus I4 includes, for example, switch units 1401 and 1402 to switch the connection relationship between the A/D converter 201 and the A/D converter 202 according to the operation mode.

In the first mode, for example, the switch units 1401 and 1402 switch the connection relationship between the A/D converters 201 and 202 so that the A/D converter 201 A/D-converts a signal from the L1th column and the A/D converter 202 A/D-converts a signal from the L2th column. On the other hand, in the second mode, the switch units 1401 and 1402 switch the connection relationship so that the A/D converters 201 and 202 parallelly perform A/D conversion processes for a signal from the L1th column.

According to the embodiment, in the first mode, the image sensing apparatus I4 operates the A/D converter provided on each column to correspond to a pixel signal readout operation for the column. On the other hand, in the second mode, the image sensing apparatus I4 operates the A/D converter provided on each column, a pixel signal readout operation from which is omitted in synchronism with the A/D converter provided on each column, a pixel signal readout operation from which is performed. Therefore, in the second mode, the image sensing apparatus I4 realizes the same effects as those in the first to third embodiments. Note that although the arrangement in which a pixel signal is read out from each pixel of the odd-numbered columns in the second mode has been described, a pixel signal may be read out from each pixel of the even-numbered columns.

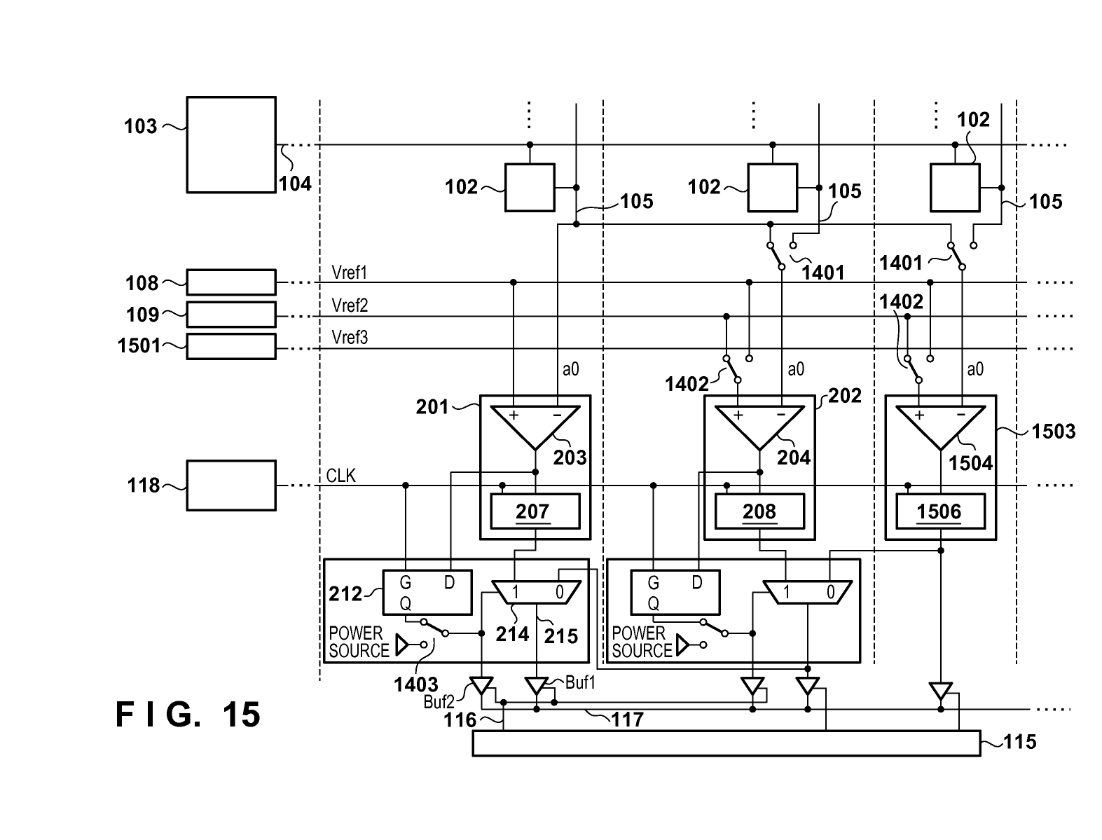

A thinning readout operation in the second mode may be configured to read out a signal from the pixel array 101 every three columns. For example, an image sensing apparatus I4a exemplified in FIG. 15 may be formed. In the second mode, the image sensing apparatus I4a reads out a pixel signal from each pixel every three columns (every third column). In this example, three columns (the L1th, L2th, and L3th columns) of a pixel array 101 will be exemplified. Assume that m represents an integer. In this case, an A/D converter 201 is arranged on the L1th column (L1=3m−2). An A/D converter 202 is arranged on the L2th column (L2=3m−1). An A/D converter 1503 is arranged on the L3th column (L3=3m).

For example, in the first mode, switch units 1401 and 1402 switch the connection relationship between the three A/D converters so that the three A/D converters A/D-convert signals from the corresponding three columns of the pixel array 101, respectively. More specifically, the switch units 1401 and 1402 switch the connection relationship so that the A/D converter 201 A/D-converts the signal from the L1th column, the A/D converter 202 A/D-converts the signal from the L2th column, and the A/D converter 1503 A/D-converts the signal from the L3th column.

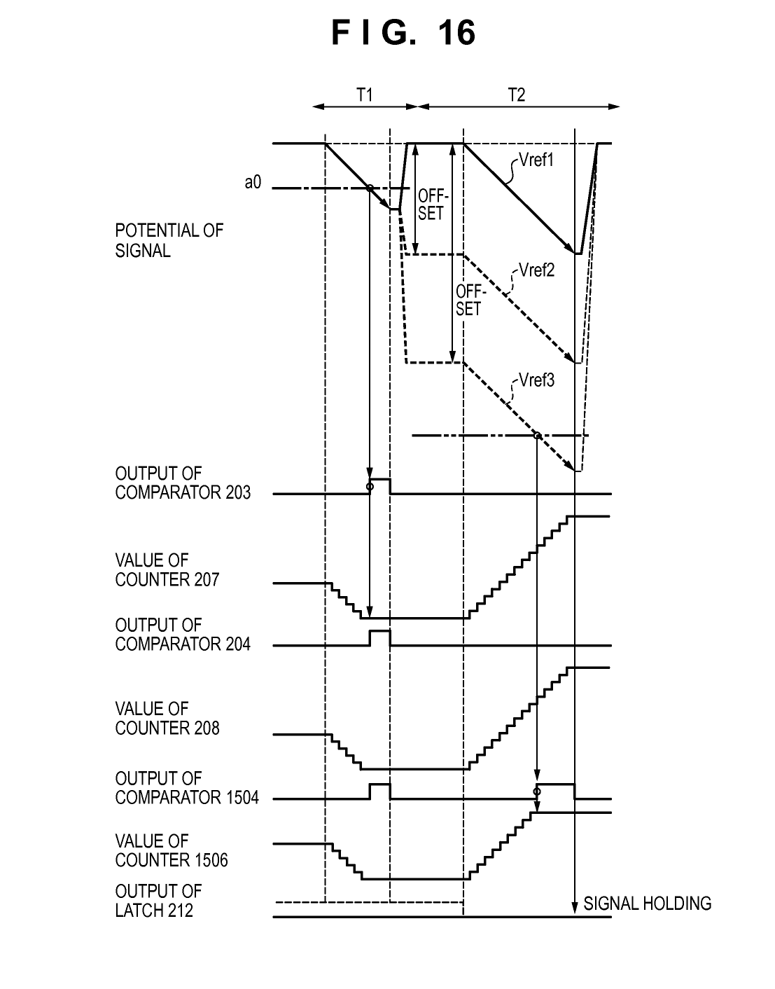

On the other hand, in the second mode, the switch units 1401 and 1402 switch the connection relationship so that the A/D converters 201, 202, and 1503 parallelly perform A/D conversion processes for the signal from the L1th column. FIG. 16 is a timing chart showing the operation of the image sensing apparatus I4a when the luminance level is high, similarly to each of the above-described embodiments.

Although the four embodiments have been explained above, the present invention is not limited to them, and can be changed, as needed, in accordance with the objects, states, applications, functions, and other specifications. Other embodiments can also practice the present invention.

(Image Sensing System)

The image sensing apparatus included in the image sensing system represented by a camera or the like has been described in each of the aforementioned embodiments. The image sensing system conceptually includes not only a device whose principal purpose is photographing but also a device (for example, a personal computer or portable terminal) additionally provided with a photographing function. The image sensing system can include the image sensing apparatus according to the present invention, which has been exemplified in the above embodiments, and a processing unit for processing a signal output from the image sensing apparatus. The processing unit can include, for example, an A/D converter, and a processor for processing digital data output from the A/D converter.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-012437, filed Jan. 25, 2013, which is hereby incorporated by reference herein in its entirety.

What is claimed is:

1. An image sensing apparatus comprising:
a pixel array in which a plurality of pixels are arranged to form a plurality of rows and a plurality of columns;
a first A/D converter configured to perform first analog-to-digital conversion for a signal from the pixel array;
a second A/D converter configured to perform second analog-to-digital conversion for the signal from the pixel array in parallel with the first analog-to-digital conversion by the first A/D converter;
a first output unit configured to output one of a first result obtained by the first analog-to-digital conversion performed by the first A/D converter and a second result obtained by the second analog-to-digital conversion performed by the second A/D converter; and
a second output unit configured to output information indicating which of the first result and the second result has been output from the first output unit.

2. The apparatus according to claim 1, wherein
the first A/D converter performs the first analog-to-digital conversion by comparing the signal from the pixel array with a first reference signal,
the second A/D converter performs the second analog-to-digital conversion by comparing the signal from the pixel array with a second reference signal different from the first reference signal, and
the first reference signal is used for comparison with a signal falling within one of a first range and a second range of a dynamic range of the signal from the pixel array, and the second reference signal is used for comparison with a signal falling within the other of the first range and the second range.

3. The apparatus according to claim 2, wherein
the first reference signal and the second reference signal are ramp signals, and
the second reference signal has the same slope as that of the first reference signal, and includes an offset component with respect to the first reference signal.

4. The apparatus according to claim 3, further comprising
a signal output unit and a capacitor,
wherein the signal output unit uses the ramp signal output after charging the capacitor as the first reference signal, and uses a signal including a voltage of the capacitor generated by the charging as the offset component with respect to the first reference signal as the second reference signal.

5. The apparatus according to claim 2, wherein
the first reference signal and the second reference signal are ramp signals, and
the first range and the second range have different range widths, and a ratio between a slope of the first reference signal and a slope of the second reference signal depends on a ratio between the range width of the first range and the range width of the second range.

6. The apparatus according to claim 2, wherein
the first A/D converter includes a counter configured to perform at least one of a count-up operation and a count-down operation and measure a time until a magnitude relationship between the signal from the pixel array and the first reference signal is reversed, and
the second A/D converter includes a counter configured to perform at least one of a count-up operation and a count-down operation and measure a time until a magnitude relationship between the signal from the pixel array and the second reference signal is reversed.

7. The apparatus according to claim 1, further comprising
a first unit configured to output a constant signal having a polarity different from that of the signal from the pixel array, and
a second unit connected to the first unit or the pixel array and configured to integrate a signal from the first unit after integrating the signal from the pixel array,
wherein the first A/D converter performs the first analog-to-digital conversion by comparing a signal output from the second unit with a first reference signal,
the second A/D converter performs the second analog-to-digital conversion by comparing the signal output from the second unit with a second reference signal different from the first reference signal, and
the first reference signal is used for comparison with a signal falling within one of a first range and a second range of a dynamic range of the signal output from the second unit, and the second reference signal is used for comparison with a signal falling within the other of the first range and the second range.

8. The apparatus according to claim 1, wherein
the first A/D converter includes a first register, a first D/A converter configured to convert a value of the first register into a first analog signal based on a first reference signal, and a first comparator configured to compare the signal from the pixel array with the first analog signal,
the second A/D converter includes a second register, a second D/A converter configured to convert a value of the second register into a second analog signal based on a second reference signal, and a second comparator configured to compare the signal from the pixel array with the second analog signal, and
the first analog signal is used for comparison with a signal falling within one of a first range and a second range of a dynamic range of the signal from the pixel array, and the second analog signal is used for comparison with a signal falling within the other of the first range and the second range.

9. The apparatus according to claim 1, wherein
one of the first result and the second result from the first output unit and the information from the second output unit are output as a digital signal containing the information as a one-bit header.

10. The apparatus according to claim 1, wherein
the first A/D converter is arranged on each of the plurality of columns of the plurality of pixels, and the second A/D converter is arranged on each of the plurality of columns.

11. The apparatus according to claim 1, further comprising a switch unit,
wherein a first mode in which a signal is read out from each of the plurality of columns of the pixel array and a second mode in which a signal is read out from each column of a first group of the plurality of columns are included as operation modes, and
in the first mode, the switch unit associates the first A/D converter with one column of the first group and the second A/D converter with one column of a second group different from the first group, and
in the second mode, the switch unit associates the first A/D converter with one column of the first group and the second A/D converter with the one column.

12. The apparatus according to claim 1, wherein
the first output unit includes a selector configured to select one of the first result and the second result based on an output of the first A/D converter.

13. The apparatus according to claim 12, wherein
the first output unit further includes a latch configured to hold the output of the first A/D converter.

14. An image sensing system comprising:
an image sensing apparatus according to claim 1; and
a processing unit configured to process a signal output from the image sensing apparatus.

15. A driving method for an image sensing apparatus including a pixel array in which a plurality of pixels are arranged to form a plurality of rows and a plurality of columns, comprising:
a first conversion step of performing first analog-to-digital conversion for a signal from the pixel array;
a second conversion step of performing second analog-to-digital conversion for the signal from the pixel array in parallel with the first conversion step;
a first output step of outputting one of a first result obtained in the first conversion step and a second result obtained in the second conversion step; and
a second output step of outputting information indicating which of the first result and the second result has been output in the first output step.
